(19) United States
(12) Patent Application Publication
(10) Pub. No.: US 2026/0171900 A1
(43) Pub. Date: Jun. 18, 2026

(54) POWER CONVERTER

(71) Applicant: CHICONY POWER TECHNOLOGY CO., LTD., New Taipei City (TW)

(72) Inventors: Min-Han LEE, New Taipei City (TW); Po-Hao MAI, New Taipei City (TW)

(21) Appl. No.: 19/051,453

(22) Filed: Feb. 12, 2025

(30) Foreign Application Priority Data
Dec. 13, 2024 (TW) 113148698

(51) Int. Cl. H02M 1/34; H02M 3/335

(52) U.S. Cl. CPC H02M 1/348; H02M 3/33507

(57) ABSTRACT

A power converter includes a conversion circuit, a controller, a snubber circuit, and an energy storage component. The conversion circuit receives an input voltage and outputs an output voltage. The controller is coupled to the conversion circuit, and is used to control the conversion circuit to adjust the output voltage. The snubber circuit is coupled between the conversion circuit and the controller, and is used to provide a snubber voltage. The energy storage component is used to receive the snubber voltage as an operating voltage for the controller. The controller, the energy storage component, and the snubber circuit for coupled to a first node.

### BACKGROUND

### Technical Field

The present disclosure relates to a power converter, and particularly to power converter with functions of spike suppression and energy recovery.

### Description of Related Art

The statements in this section merely provide background information related to the present disclosure and do not necessarily constitute prior art.

The traditional flyback converter has the advantages of simple circuit structure and low cost, and therefore this topology is widely used in medium and small wattage power supply products. However, due to the use of a transformer in the structure, its leakage inductance energy will generate a spike voltage on the main switch Q when the switch is instantaneously turned off. Therefore, in order to prevent the main switch Q from being damaged by exceeding the rated voltage and reduce electromagnetic interference, a traditional RCD snubber will be used to suppress this spike voltage. The traditional RCD snubber consists of a resistor R, a capacitor C, and a diode D. In particular, the capacitor C is used to temporarily store the energy of the spike voltage to suppress the amplitude of the transient voltage, and the energy stored in the capacitor C is discharged through the resistor R.

For the traditional RCD snubber, when the main switch Q is turned on, the energy stored in the capacitor C in the previous stage will be released through the resistor R, and when the main switch Q is turned off, the capacitor C stores the leakage inductance energy, and the resistor R will consume energy. Therefore, the resistor R is in an energy-consumed condition no matter when the main switch Q is turned on or turned off. In addition, when the output load increases, in order to provide more energy to the output side, the turned-on time of the main switch Q will become longer, and the leakage inductance energy will increase, thereby causing a larger spike voltage to be generated on the main switch Q. Furthermore, the traditional RCD snubber shown in FIG. 1 is only used to suppress spike voltage and cannot recycle the stored energy.

Therefore, how to design a power converter to solve the problems and technical bottlenecks in the existing technology has become a critical topic in this field.

### SUMMARY

An objective of the present disclosure is to provide a power converter. The power converter includes a conversion circuit, a controller, a snubber circuit, and an energy storage component. The conversion circuit receives an input voltage and outputs an output voltage. The controller is coupled to the conversion circuit, and the controller controls the conversion circuit to adjust the output voltage. The snubber circuit is coupled between the conversion circuit and the controller, and the snubber circuit provides a snubber voltage. The energy storage component receives the snubber voltage as an operating voltage for the controller. The controller, the energy storage component, and the snubber circuit are coupled to a first node.

In one embodiment, the conversion circuit includes a transformer and a switch unit. The transformer converts the input voltage into the output voltage, and the transformer includes a leakage inductance. The switch unit is controlled to adjust the output voltage of the conversion circuit. The transformer, the switch unit, and the snubber circuit are coupled to a second node. When the switch unit is turned on, a current flows through the leakage inductance, and the leakage inductance is in an energy storage stage.

In one embodiment, the power converter further includes an auxiliary circuit. The auxiliary circuit includes an auxiliary winding and a first diode. The auxiliary winding induces magnetic energy of the transformer to provide an auxiliary voltage. The first diode is coupled between the first node and the auxiliary winding. The energy storage component receives the auxiliary voltage as the operating voltage for the controller through the first diode.

In one embodiment, the snubber circuit includes a first capacitor, an energy release unit, and a second diode. The first capacitor is coupled to the second node. The energy release unit is coupled between the first capacitor and the switch unit. The second diode is coupled between the first node and the first capacitor. The first capacitor, the energy release unit, and the second diode are coupled to a third node. When the switch unit is turned on, a releasing path is formed by the first capacitor, the switch unit, and the energy release unit, and a current with a first current value flows through the releasing path.

In one embodiment, the energy release unit includes a third diode and a first resistor. The third diode is coupled to the switch unit. The first resistor is coupled to the third node and connected to the third diode in series.

In one embodiment, when the switch unit is turned off, a charging path is formed by the first capacitor and the second diode, and a current with a second current value flows through the charging path.

In one embodiment, the snubber circuit further includes a second resistor coupled between the first node and the second diode. The charging path is formed by the first capacitor, the second diode, and the second resistor, and a current with a third current value flows through the charging path, and the second current value is greater than the third current value.

In one embodiment, the snubber circuit further includes a third resistor coupled between the second node and the first capacitor. When the switch unit is turned on, the releasing path is formed by the first capacitor, the third resistor, the switch unit, and the energy release unit, and a current with a fourth current value flows through the releasing path, and the first current value is greater than the fourth current value. When the switch unit is turned off, the charging path is formed by the third resistor, the first capacitor, and the second diode, and a current with a fifth current value flows through the charging path, and the second current value is greater than the fifth current value.

In one embodiment, the snubber circuit further includes a second capacitor coupled to the first resistor in parallel. When the switch unit is turned on, the releasing path is formed by the first capacitor, the switch unit, the third diode, the first resistor, and the second capacitor, and a current with a sixth current value flows through the releasing path, and the first current value is less than the sixth current value.

In one embodiment, the snubber circuit further comprises a second capacitor coupled to the first resistor in parallel. When the switch unit is turned on, the releasing path is formed by the first capacitor, the switch unit, the third diode, the first resistor, and the second capacitor, and a current with a sixth current value flows through the releasing path, and the first current value is less than the sixth current value.

In one embodiment, the snubber circuit further includes a second capacitor coupled to the first resistor in parallel. When the switch unit is turned on, the releasing path is formed by the first capacitor, the third capacitor, the switch unit, the third diode, the first resistor, and the second capacitor, and a current with a seventh current value flows through the releasing path, and the fourth current value is less than the seventh current value.

In one embodiment, the snubber circuit further includes a fourth resistor coupled to the second capacitor in series, and the fourth resistor and the second capacitor are coupled to the first resistor in parallel. When the releasing path is formed by the first capacitor, the switch unit, the third diode, the first resistor, the fourth resistor, and the second capacitor, and a current with an eighth current value flows through the releasing path, and the sixth current value is greater than the eighth current value.

Therefore, the power converter of the present disclosure has the following features and advantages: 1. In terms of component usage, compared with the traditional RCD snubber, the snubber circuit of the present disclosure only adds one diode component, which can not only maintain the function of suppressing the spike voltage on the switch unit, but also add the function of recovering the energy of the leakage inductance; 2. In terms of circuit design, the energy of the leakage inductance of the flyback power converter can be directly electrically connected to the controller (such as a PWM controller) through the snubber circuit, and transmitted to as the operating voltage of the controller for use without conversion or any other stage of operation; 3. The snubber circuit operates when the switch unit is turned on: the energy stored in the first capacitor of the snubber circuit in the previous stage will be released through the first resistor. Since the time for the first capacitor of the snubber circuit to release energy is proportional to the turned-on time of the switch unit, when the flyback power converter operates in light load, the switch unit has a short turned-on time, and the first capacitor releases less energy to the first resistor, and therefore the consumption on the first resistor will be reduced, thereby acquiring higher light-load efficiency; 4. The snubber circuit operates when the switch unit is turned off: the energy of the leakage inductance recovered through the snubber circuit is directly transmitted to as the operating voltage of the controller, and the first resistor does not generate any consumption during the process; 5. During the turned-on stage of the switch unit, the first capacitor is allowed to release more energy so that more energy of the leakage inductance accumulated due to heavy-load requirements can be absorbed in the next stage and transmitted to as the operating voltage of the controller, and therefore this function can be achieved without adding additional controllers.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a circuit diagram of a traditional flyback power converter with an RCD snubber.

FIG. 2 is a block diagram of a power converter according to the present disclosure.

FIG. 3 is a block circuit diagram of the power converter according to a first embodiment of the present disclosure.

FIG. 4 is a block circuit diagram of the power converter of FIG. 3 further including an auxiliary circuit.

FIG. 5 is a block circuit diagram of the power converter according to a second embodiment of the present disclosure.

FIG. 6 is a block circuit diagram of the power converter according to a third embodiment of the present disclosure.

FIG. 7 is a block circuit diagram of the power converter according to a fourth embodiment of the present disclosure.

FIG. 8 is a block circuit diagram of the power converter according to a fifth embodiment of the present disclosure.

FIG. 9 is a block circuit diagram of the power converter according to a sixth embodiment of the present disclosure.

FIG. 10 is a block circuit diagram of the power converter according to a seventh embodiment of the present disclosure.

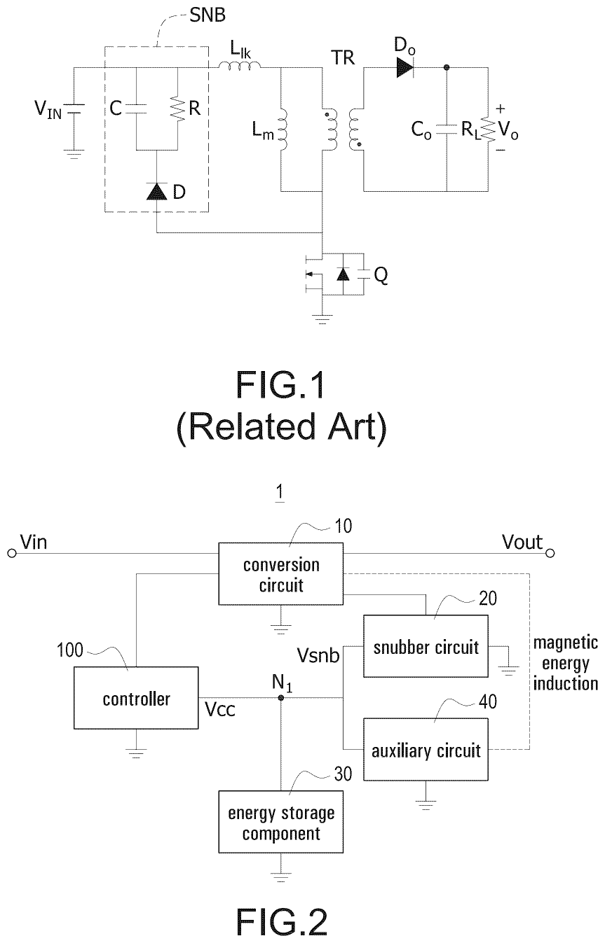

### DETAILED DESCRIPTION

Reference will now be made to the drawing figures to describe the present disclosure in detail. It will be understood that the drawing figures and exemplified embodiments of present disclosure are not limited to the details thereof.

Please refer to FIG. 2, which shows a block diagram of a power converter according to the present disclosure. The power converter 1 includes a conversion circuit 10, a snubber circuit 20, an energy storage component 30, and a controller 100 (such as a PWM controller) for controlling the power converter 1. The conversion circuit 10 receives an input voltage Vin and converts the input voltage Vin to output an output voltage Vout. The controller 100 is coupled to the conversion circuit 10, and the controller 100 controls the conversion circuit 10 to adjust the output voltage Vout. The snubber circuit 20 is coupled between the conversion circuit 10 and the controller 100, and provides a snubber voltage Vsnb. The energy storage component 30 receives the snubber voltage Vsnb as an operating voltage Vcc for the controller 100 to provide the voltage range required for the normal operation of the controller 100 to ensure that the controller 100 can operate stably. The controller 100, the energy storage component 30, and the snubber circuit 20 are coupled to a first node N₁.

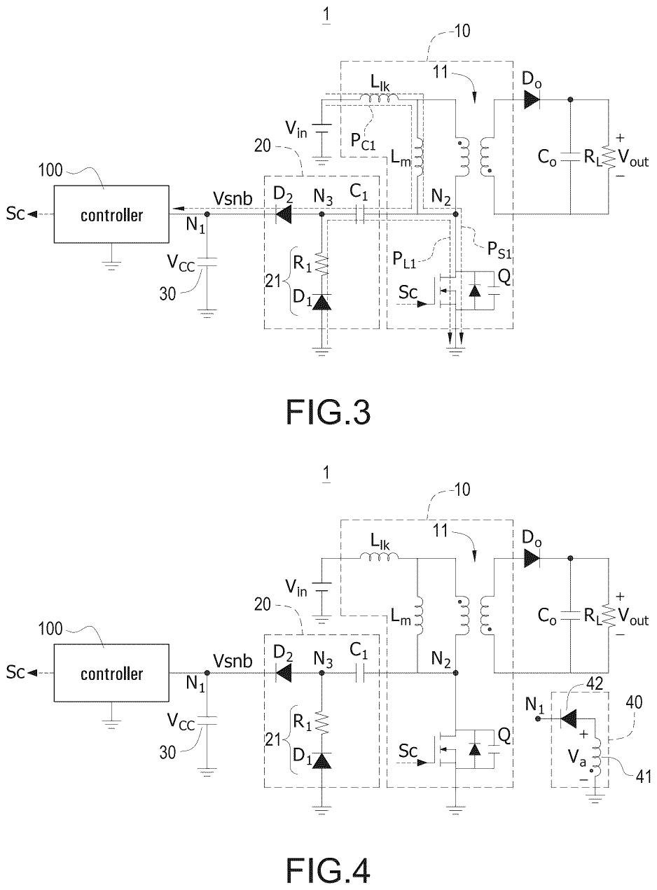

Please refer to FIG. 3, which shows a block circuit diagram of the power converter according to a first embodiment of the present disclosure, and also refer to FIG. 2. FIG. 3 further illustrates the specific circuit of FIG. 2. As shown in FIG. 3, the conversion circuit 10 mainly includes a transformer 11 and a switch unit Q. The transformer 11 converts the input voltage Vin into the output voltage Vout, and the transformer 11 mainly includes a leakage inductance Lₗₖ and a magnetizing inductance Lₘ. The switch unit Q is controlled to adjust the output voltage Vout of the conversion circuit 10. In particular, the transformer 11, the switch unit Q, and the snubber circuit 20 are coupled to a second node N₂.

Please refer to FIG. 4, which shows a block circuit diagram of the power converter of FIG. 3 further including an auxiliary circuit. The power converter 1 shown in FIG. 3 further includes an auxiliary circuit 40. The auxiliary circuit 40 includes an auxiliary winding 41 and a first diode 42. The auxiliary winding 41 induces magnetic energy of the transformer 11 to provide an auxiliary voltage Va. The first diode 42 is coupled between the first node N₁ and the auxiliary winding 41. The energy storage component 30 receives the auxiliary voltage Va as the operating voltage Vcc for the controller 100 through the first diode 42. Therefore, the operating voltage Vcc of the controller 100 can be realized through the snubber voltage Vsnb provided by the snubber circuit 20 or through the auxiliary voltage Va provided by the auxiliary winding 41.

Please refer to FIG. 3 again, in the first embodiment of the present disclosure, the snubber circuit 20 includes a first capacitor C₁, an energy release unit 21, and a second diode D₂. A first terminal of the first capacitor C₁ is coupled to the second node N₂. The energy release unit 21 is coupled between a second terminal of the first capacitor C₁ and the switch unit Q. The second diode D₂ is coupled between the first node N₁ and the second terminal of the first capacitor C₁. The first capacitor C₁, the energy release unit 21, and the second diode D₂ are coupled to a third node N₃.

When a switch control signal S_{C} (for example, but not limited to, a PWM control signal) provided by the controller 100 turns on the switch unit Q, the input voltage Vin supplies power to the power converter 1 to generate a current flowing through the leakage inductance Lₗₖ and the magnetizing inductance Lₘ, and the leakage inductance Lₗₖ is in an energy storage stage. In this condition, the current flowing through the leakage inductance Lₗₖ increases linearly. An energy storing path of the leakage inductance Lₗₖ is a first energy storing path P_{S1} shown in FIG. 3. Simultaneously, when the switch unit Q is turned on, the residual energy stored in the first capacitor C₁ in the previous stage of operation is released through a releasing path (i.e., a first releasing path P_{L1} shown in FIG. 3) formed by the first capacitor C₁, the switch unit Q, and the energy release unit 21. In particular, the current with a first current value flows through the first releasing path P_{L1}.

In the first embodiment shown in FIG. 3, the energy release unit 21 includes a third diode D₁ and a first resistor R₁. The third diode D₁ is coupled to the switch unit Q. The first resistor R₁ is coupled to the third node N₃ and connected to the third diode D₁ in series. When the switch control signal S_{C} provided by the controller 100 turns off the switch unit Q, a charging path (i.e., a first charging path P_{C1} shown in FIG. 3) is formed by the first capacitor C₁ and the second diode D₂, and a current with a second current value flows through the first charging path P_{C1}. Moreover, the energy stored in the magnetizing inductance Lₘ is transferred to an output side of the power converter 1 through the transformer 11. In this condition, the energy stored in the leakage inductance Lₗₖ cannot be transferred to a secondary side of the transformer 11, and therefore the leakage inductance Lₗₖ resonates with a parasitic capacitance of the switch unit Q on the path.

In addition, the first capacitor C₁ on the first charging path P_{C1} is used to suppress the spike voltage, and the energy flowing through the second diode D₂ (that is, the energy of the leakage inductance Lₗₖ) can be recovered and used, for example, but not limited to, for providing power required for normal operation of the controller 100. Therefore, compared with traditional RCD snubber that directly convert energy into heat energy consumption, the present disclosure further recycles and reuses the energy of the leakage inductance Lₗₖ to increase conversion efficiency and reduce heat generation. In other words, when the switch unit Q is turned off, some energy of the leakage inductance Lₗₖ not only flows through a path of the parasitic capacitance of the switch unit Q, but also flows through the first capacitor C₁ and the second diode D₂ to be stored in the energy storage component 30 to be used as the operating voltage Vcc of the controller 100. Furthermore, since the residual energy stored in the first capacitor C₁ is quite completely discharged (closer to zero) when the switch unit Q is turned on, when the switch unit Q is turned off, the effect of clamping (suppressing) the spike voltage by the first capacitor C₁ is more ideal, and the energy of the leakage inductance Lₗₖ that can be stored in the first capacitor C₁ is further increased. This feature and advantage can also be fully realized in other embodiments, and therefore other embodiments will not be described in detail later.

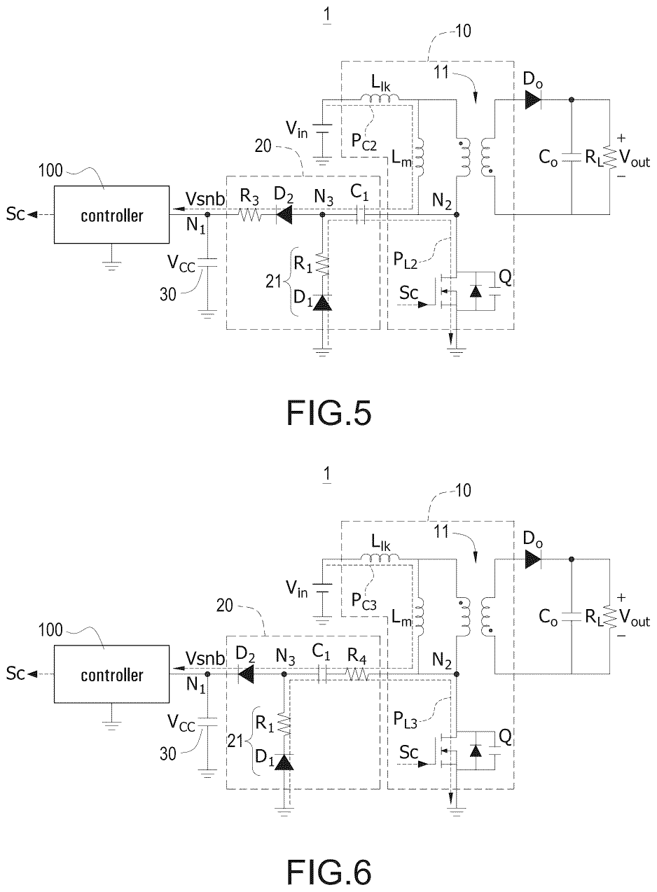

Please refer to FIG. 5, which shows a block circuit diagram of the power converter according to a second embodiment of the present disclosure. Compared with the first embodiment shown in FIG. 3, the snubber circuit 20 of the second embodiment shown in FIG. 5 further includes a second resistor R₃. The second resistor R₃ is used to provide current limiting when the switch unit Q is turned off to prevent the occurrence of large current. The second resistor R₃ is coupled between the first node N₁ and the second diode D₂. When the switch unit Q is turned on, the residual energy stored in the first capacitor C₁ is released through a releasing path (i.e., a second releasing path P_{L2} shown in FIG. 5) formed by the first capacitor C₁, the switch unit Q, and the energy release unit 21. In particular, the current with a first current value flows through the second releasing path P_{L2}. Moreover, when the switch unit Q is turned off, a charging path (i.e., a second charging path P_{C2} shown in FIG. 5) is formed by the first capacitor C₁, the second diode D₂, and the second resistor R₃, and a current with a third current value flows through the second charging path P_{C2}. In particular, the second current value of the first charging path P_{C1} shown in FIG. 3 is greater than the third current value of the second charging path P_{C2} shown in FIG. 5.

Please refer to FIG. 6, which shows a block circuit diagram of the power converter according to a third embodiment of the present disclosure. Compared with the second embodiment shown in FIG. 5, the snubber circuit 20 of the third embodiment shown in FIG. 6 further includes a third resistor R₄. The third resistor R₄ is used to provide current limiting when the switch unit Q is turned on and turned off to prevent the occurrence of large current. The third resistor R₄ is coupled between the second node N₂ and the first capacitor C₁. When the switch unit Q is turned on, the residual energy stored in the first capacitor C₁ is released through a releasing path (i.e., a third releasing path P_{L3} shown in FIG. 6) formed by the first capacitor C₁, the third resistor R₄, the switch unit Q, and the energy release unit 21. In particular, the current with a fourth current value flows through the third releasing path P_{L3}. In particular, the first current value of the first releasing path P_{L1} shown in FIG. 3 or the second releasing path P_{L2} shown in FIG. 5 is greater than the fourth current value of the third releasing path P_{L3} shown in FIG. 6. Moreover, when the switch unit Q is turned off, a charging path (i.e., a third charging path P_{C3} shown in FIG. 6) is formed by the third resistor R₄, the first capacitor C₁, and the second diode D₂, and a current with a fifth current value flows through the third charging path P_{C3}. In particular, the second current value of the first charging path P_{C1} shown in FIG. 3 is greater than the fifth current value of the third charging path P_{C3} shown in FIG. 6.

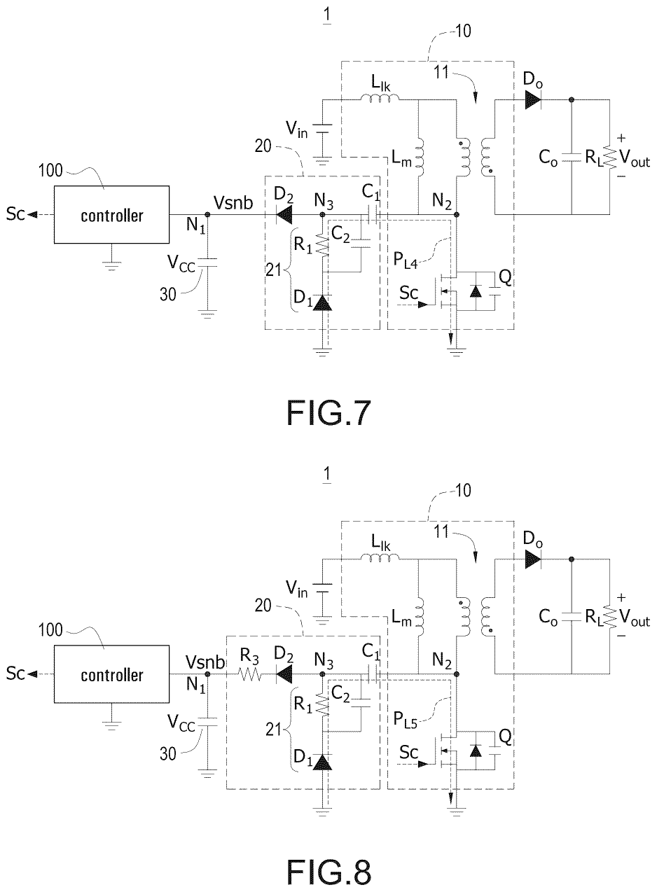

Please refer to FIG. 7, which shows a block circuit diagram of the power converter according to a fourth embodiment of the present disclosure. Compared with the first embodiment shown in FIG. 3, the snubber circuit 20 of the fourth embodiment shown in FIG. 7 further includes a second capacitor C₂. The second capacitor C₂ is used to accelerate the discharging of the first capacitor C₁ when the switch unit Q is turned on, and to enable the first capacitor C₁ to absorb more energy of the leakage inductance Lₗₖ when the switch unit Q is turned off. The second capacitor C₂ is coupled to the first resistor R₁ in parallel. When the switch unit Q is turned on, the residual energy stored in the first capacitor C₁ is released through a releasing path (i.e., a fourth releasing path P_{L4} shown in FIG. 7) formed by the first capacitor C₁, the switch unit Q, the third diode D₁, the first resistor R₁, and the second capacitor C₂. In particular, the current with a sixth current value flows through the fourth releasing path P_{L4}. In particular, the first current value of the first releasing path P_{L1} shown in FIG. 3 or the second releasing path P_{L2} shown in FIG. 5 is less than the sixth current value of the fourth releasing path P_{L4} shown in FIG. 7. Moreover, when the switch unit Q is turned off, a charging path is formed by the first capacitor C₁ and the second diode D₂ is the same as the first charging path P_{C1} shown in FIG. 3, and it will not be described in detail here.

Please refer to FIG. 8, which shows a block circuit diagram of the power converter according to a fifth embodiment of the present disclosure. Compared with the second embodiment shown in FIG. 5, the snubber circuit 20 of the fifth embodiment shown in FIG. 8 further includes a second capacitor C₂. The second capacitor C₂ is coupled to the first resistor R₁ in parallel. When the switch unit Q is turned on, the residual energy stored in the first capacitor C₁ is released through a releasing path (i.e., a fifth releasing path P_{L5} shown in FIG. 8) formed by the first capacitor C₁, the switch unit Q, the third diode D₁, the first resistor R₁, and the second capacitor C₂. In particular, the current with a sixth current value flows through the fifth releasing path P_{L5}. In particular, the first current value of the first releasing path P_{L1} shown in FIG. 3 or the second releasing path P_{L2} shown in FIG. 5 is less than the sixth current value of the fifth releasing path P_{L5} shown in FIG. 8. Moreover, when the switch unit Q is turned off, a charging path is formed by the first capacitor C₁, the second diode D₂, and the second resistor R₃ is the same as the second charging path P_{C2} shown in FIG. 5, and it will not be described in detail here.

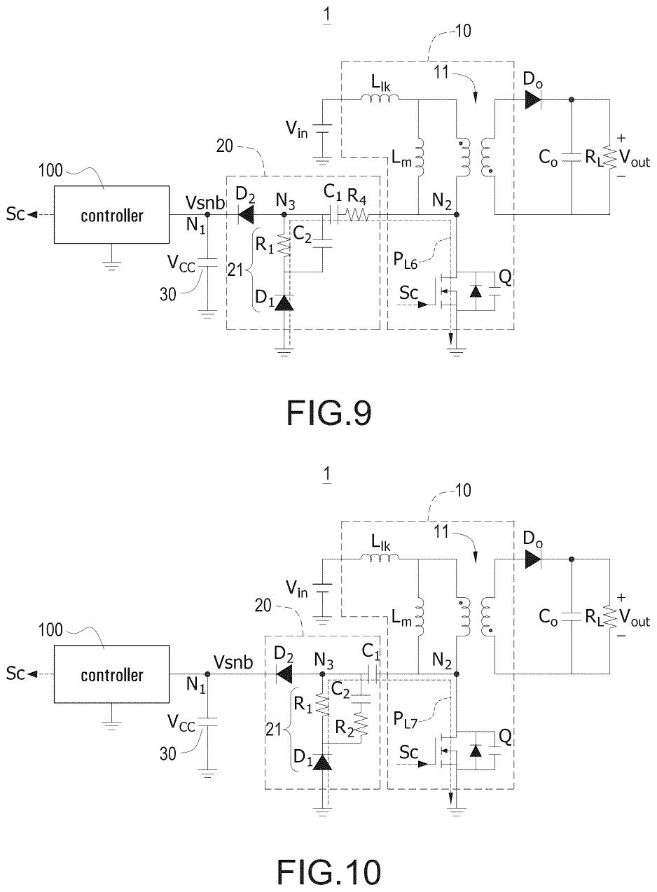

Please refer to FIG. 9, which shows a block circuit diagram of the power converter according to a sixth embodiment of the present disclosure. Compared with the third embodiment shown in FIG. 6, the snubber circuit 20 of the sixth embodiment shown in FIG. 9 further includes a second capacitor C₂. The second capacitor C₂ is coupled to the first resistor R₁ in parallel. When the switch unit Q is turned on, the residual energy stored in the first capacitor C₁ is released through a releasing path (i.e., a sixth releasing path P_{L6} shown in FIG. 9) formed by the first capacitor C₁, the third resistor R₄, the switch unit Q, the third diode D₁, the first resistor R₁, and the second capacitor C₂. In particular, the current with a seventh current value flows through the sixth releasing path P_{L6}. In particular, the fourth current value of the third releasing path P_{L3} shown in FIG. 6 is less than the seventh current value of the sixth releasing path P_{L6} shown in FIG. 9. Moreover, when the switch unit Q is turned off, a charging path is formed by the third resistor R₄, the first capacitor C₁, and the second diode D₂ is the same as the third charging path P_{C3} shown in FIG. 6, and it will not be described in detail here.

Please refer to FIG. 10, which shows a block circuit diagram of the power converter according to a seventh embodiment of the present disclosure. Compared with the fourth embodiment shown in FIG. 7, the snubber circuit 20 of the seventh embodiment shown in FIG. 10 further includes a fourth resistor R₂. The fourth resistor R₂ is used to provide current limiting when the switch unit Q is turned on to prevent the occurrence of large current. The fourth resistor R₂ is coupled to the second capacitor C₂ in series, and the series-connected fourth resistor R₂ and second capacitor C₂ are coupled to the first resistor R₁ in parallel. When the switch unit Q is turned on, the residual energy stored in the first capacitor C₁ is released through a releasing path (i.e., a seventh releasing path P_{L7} shown in FIG. 10) formed by the first capacitor C₁, the switch unit Q, the third diode D₁, the first resistor R₁, the fourth resistor R₂, and the second capacitor C₂. In particular, the current with an eighth current value flows through the seventh releasing path P_{L7}. In particular, the sixth current value of the fourth releasing path P_{L4} shown in FIG. 7 or the fifth releasing path P_{L5} shown in FIG. 8 is greater than the eighth current value of the seventh releasing path P_{L7} shown in FIG. 10. Moreover, when the switch unit Q is turned off, a charging path is formed by the first capacitor C₁ and the second diode D₂ is the same as the first charging path P_{C1} shown in FIG. 3, and it will not be described in detail here.

Therefore, the power supply device disclosed in the present disclosure has the following features and advantages:

1. In terms of component usage, compared with the traditional RCD snubber, the snubber circuit 20 of the present disclosure only adds one diode component, which can not only maintain the function of suppressing the spike voltage on the switch unit Q, but also add the function of recovering the energy of the leakage inductance Lₗₖ.

2. In terms of circuit design, the energy of the leakage inductance of the flyback power converter can be directly electrically connected to the controller 100 (such as a PWM controller) through the snubber circuit 20, and transmitted to as the operating voltage Vcc of the controller 100 for use without conversion or any other stage of operation.

3. The snubber circuit 20 operates when the switch unit Q is turned on: the energy stored in the first capacitor C₁ of the snubber circuit 20 in the previous stage will be released through the first resistor R₁. Since the time for the first capacitor C₁ of the snubber circuit 20 to release energy is proportional to the turned-on time of the switch unit Q, when the flyback power converter operates in light load, the switch unit Q has a short turned-on time, and the first capacitor C₁ releases less energy to the first resistor R₁, and therefore the consumption on the first resistor R₁ will be reduced, thereby acquiring higher light-load efficiency.

4. The snubber circuit 20 operates when the switch unit Q is turned off: the energy of the leakage inductance Lₗₖ recovered through the snubber circuit 20 is directly transmitted to as the operating voltage Vcc of the controller 100, and the first resistor R₁ does not generate any consumption during the process.

5. During the turned-on stage of the switch unit Q, the first capacitor C₁ is allowed to release more energy so that more energy of the leakage inductance Lₗₖ accumulated due to heavy-load requirements can be absorbed in the next stage and transmitted to as the operating voltage Vcc of the controller 100, and therefore this function can be achieved without adding additional controllers.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A power converter comprising:
a conversion circuit configured to receive an input voltage and output an output voltage,
a controller coupled to the conversion circuit, and the controller configured to control the conversion circuit to adjust the output voltage,
a snubber circuit coupled between the conversion circuit and the controller, and the snubber circuit configured to provide a snubber voltage, and
an energy storage component configured to receive the snubber voltage as an operating voltage for the controller,
wherein the controller, the energy storage component, and the snubber circuit are coupled to a first node.

2. The power converter as claimed in claim 1, wherein the conversion circuit comprises:
a transformer configured to convert the input voltage into the output voltage, and the transformer comprising a leakage inductance, and
a switch unit configured to be controlled to adjust the output voltage of the conversion circuit,
wherein the transformer, the switch unit, and the snubber circuit are coupled to a second node,
wherein when the switch unit is turned on, a current flows through the leakage inductance, and the leakage inductance is in an energy storage stage.

3. The power converter as claimed in claim 2, further comprising:
an auxiliary circuit comprising:
an auxiliary winding configured to induce magnetic energy of the transformer to provide an auxiliary voltage, and
a first diode coupled between the first node and the auxiliary winding,
wherein the energy storage component is configured to receive the auxiliary voltage as the operating voltage for the controller through the first diode.

4. The power converter as claimed in claim 2, wherein the snubber circuit comprises:
a first capacitor coupled to the second node,
an energy release unit coupled between the first capacitor and the switch unit, and
a second diode coupled between the first node and the first capacitor,
wherein the first capacitor, the energy release unit, and the second diode are coupled to a third node,
wherein when the switch unit is turned on, a releasing path is formed by the first capacitor, the switch unit, and the energy release unit, and a current with a first current value flows through the releasing path.

5. The power converter as claimed in claim 4, wherein the energy release unit comprises:
a third diode coupled to the switch unit, and
a first resistor coupled to the third node and connected to the third diode in series.

6. The power converter as claimed in claim 5, wherein when the switch unit is turned off, a charging path is formed by the first capacitor and the second diode, and a current with a second current value flows through the charging path.

7. The power converter as claimed in claim 6, wherein the snubber circuit further comprises a second resistor coupled between the first node and the second diode,
wherein the charging path is formed by the first capacitor, the second diode, and the second resistor, and a current with a third current value flows through the charging path, and the second current value is greater than the third current value.

8. The power converter as claimed in claim 6, wherein the snubber circuit further comprises a third resistor coupled between the second node and the first capacitor,
wherein when the switch unit is turned on, the releasing path is formed by the first capacitor, the third resistor, the switch unit, and the energy release unit, and a current with a fourth current value flows through the releasing path, and the first current value is greater than the fourth current value; when the switch unit is turned off, the charging path is formed by the third resistor, the first capacitor, and the second diode, and a current with a fifth current value flows through the charging path, and the second current value is greater than the fifth current value.

9. The power converter as claimed in claim 6, wherein the snubber circuit further comprises a second capacitor coupled to the first resistor in parallel; when the switch unit is turned on, the releasing path is formed by the first capacitor, the switch unit, the third diode, the first resistor, and the second capacitor, and a current with a sixth current value flows through the releasing path, and the first current value is less than the sixth current value.

10. The power converter as claimed in claim 7, wherein the snubber circuit further comprises a second capacitor coupled to the first resistor in parallel; when the switch unit is turned on, the releasing path is formed by the first capacitor, the switch unit, the third diode, the first resistor, and the second capacitor, and a current with a sixth current value flows through the releasing path, and the first current value is less than the sixth current value.

11. The power converter as claimed in claim 8, wherein the snubber circuit further comprises a second capacitor coupled to the first resistor in parallel; when the switch unit is turned on, the releasing path is formed by the first capacitor, the third resistor, the switch unit, the third diode, the first resistor, and the second capacitor, and a current with a seventh current value flows through the releasing path, and the fourth current value is less than the seventh current value.

12. The power converter as claimed in claim 9, wherein the snubber circuit further comprises a fourth resistor coupled to the second capacitor in series, and the fourth resistor and the second capacitor are coupled to the first resistor in parallel; when the switch unit is turned on, the releasing path is formed by the first capacitor, the switch unit, the third diode, the first resistor, the fourth resistor, and the second capacitor, and a current with an eighth current value flows through the releasing path, and the sixth current value is greater than the eighth current value.
